(19) United States
(12) Patent Application Publication
(10) Pub. No.: US 2007/0050234 A1
(43) Pub. Date: Mar. 1, 2007

(54) On-line design system and method

(76) Inventor: Scott Corlett, San Diego, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/213,216

(22) Filed: Aug. 25, 2005

(51) Int. Cl. G06F 17/30

(52) U.S. Cl. 705/10

(57) ABSTRACT

An online design system and method are provided. In a preferred embodiment, a landscape design system and method are provided. The system may provide interactive collaboration of one or more plans associated with a design project.

### FIELD OF THE INVENTION

The invention relates generally to a system and method for performing online design and in particular to a computer-implemented web-based online design system and method.

### BACKGROUND OF THE INVENTION

Typically, when a consumer would like to have something designed for them, such as a new house, an addition, a landscape, a remodel and the like, the consumer would need to employ a professional designer to assist with the design. For example, to design a remodel, the consumer might engage a contractor as well as an architect. The typical design process is very slow and expensive. The process typically requires multiple face-to-face meetings to ensure that the design is correct and meets with the approval of the consumer. For the professional performing the design work, the design process is also slow and does not easily lend itself to scaling as the amount of work that can be done is limited by the time spent with each consumer. For example, in the field of landscape construction, the typical design process involves a number of meetings at the site of the landscape. However, this typical design process is not easily scaleable, the workforce of landscape designers are uneducated and difficult to manage in the field, and the industry lacks professionalism. Furthermore, it is very difficult for the owner of the landscape contracting business to maintain a level of quality so that customers became frustrated. Thus, it is desirable to provide a computer-implemented online design system and method that is more easily scaleable, delivers better results to the consumers and provides more control over the design process for the designer and it is to this end that the present invention is directed.

### SUMMARY OF THE INVENTION

A computer implemented online design system and method are provided in which a templated process and a team method of real-time web delivery using in-house, on-line designers is used. In a preferred embodiment, a templated process and a team method of real-time web delivery using in-house, hardscape designers, horticulturists and CAD engineers provide online landscape design. The system is scaleable, provides maximum benefit to the consumer at a lower cost and permits the manager to control the quality of the online design being provided. The online design system eliminates the problem of the distance to a job, the cost of sending individuals to those sites and the need for control of the client experience at the job sites. The system provides these advantages using a centralized delivery model that can be monitored, templated and controlled. The system provides the consumer with access to various professionals and specialists, such as landscape designers, horticulturists, irrigation experts, lighting designers, and CAD engineers in the preferred embodiment of a landscape design system, all in one place online which is far superior to any individual designer coming to their property. The system provides a very organized methodical templated process of online design that takes the consumer down a path of development with qualified experts at every point in order to deliver a world class experience to every client every time. The system also provides an interactive online environment in which the consumer has access to these professionals and experts in real time.

The system may generate a cohesive, unified master concept plan based on the expertise of the system's experts and the consumer receives hard copies of the completed plan drawings for bids. The plans represent the exact project and not just an idea of what the project will be so that there should be no surprises, changes or charges once construction begins. The system may also provide the consumer with assistance in shopping their project around and in getting accurate bids allowing them to choose the best contractor for their project. For example, the bids from 4 contractors on a typical $50k project typically come in varying from $40k to $60k. With a $20k swing in pricing on a $50k construction job it is clear that the only way for a client to be sure they are getting a fair deal is to have plans developed and have them shopped for reasonable pricing. The client saves the money they pay for plans many times over by going out to competitive bid using the design plans provided by the online design system.

The system provides templates to the customer which provides each client with the same design process each time. The system is process driven and takes the client through all of the necessary steps required to develop a full landscape design. Without the templates, a client typically does not receive a consistent quality of service. The templates also permit the overall design process to be constantly reviewed, enhanced and fine tuned. The fine tuning process gives the system the ability to improve the process at many levels. For example, the quality of the presentation, interaction with the client, understanding the client's needs, the time to process a design, the hand off points to other departments, etc. The on-line design system in accordance with the invention also includes a web conferencing process that has eliminated the traditional geographical restrictions of landscape design.

Thus, in accordance with the invention, a system for online design is provided that comprises a storage unit containing one or more pieces of information about a design project, a first computer connected to the storage unit and one or more client computers that connect to the first computer over a network wherein the client computers further comprise a client computer and a designer computer. In the system, the first computer has a design tool having a web collaboration module and an image library stored in the storage unit. The web collaboration module permits a client and a designer to interactively collaborate on the design project over the network using the client computer and the designer computer so that the collaboration produces a set of plans for the design project that are stored in the storage unit. The image library has a plurality of images of a plurality of different aspects of the design project so that, prior to using the web collaboration module, the client selects one or more images from the image library to identify one or more desired aspects of the design project.

In accordance with another aspect of the invention, a method for on-line design of a design project is provided. During the method, the user responds to a series of design project questions wherein the responses to the questions are stored in a storage unit and also selects one or more images from an image library, wherein the selected images are images of different aspects of the design project. The system then generates a set of design plans based on the selected images and the responses to the questions. Then, the user and the designer finalize the set of design plans based on a collaborative interaction between a designer and a client wherein the designer and client can both modify the set of design plans.

### BRIEF DESCRIPTION OF THE DRAWINGS

FIG. 1A is a block diagram illustrating a web-based on-line design system in accordance with the invention;

FIG. 1B is a diagram illustrating more details of the on-line design process in accordance with the invention;

FIG. 1C is a diagram illustrating the web collaboration used in the on-line design process shown in FIG. 1B;

FIG. 1D illustrates an example of the on-line design web collaboration in accordance with the invention;

FIG. 2A is a diagram illustrating more details of the main computer shown in FIG. 1;

FIG. 2B is a diagram illustrating more details of the database for the on-line design system in accordance with the invention;

FIG. 3 is a diagram illustrating more details of each design team computer;

FIG. 4 is a diagram illustrating an exemplary layout for the website shown in FIG. 1;

FIG. 5 illustrating an on-line design method in accordance with the invention;

FIG. 6 illustrates more details of the new client process shown in FIG. 5;

FIG. 7 illustrates more details of the design preparation process shown in FIG. 5;

FIG. 8 illustrates more details of the hardscape plan design process shown in FIG. 5;

FIG. 9 illustrates more details of the horticulture design process shown in FIG. 5;

FIG. 10 illustrates more details of the computer aided design (CAD) process shown in FIG. 5;

FIG. 11 illustrates more details of the final delivery process shown in FIG. 5;

FIG. 12 illustrates more details of the PVP process shown in FIG. 5;

FIGS. 13A-F are examples of the design plan generated by the system in accordance with the invention;

FIG. 14A-14M are an example of an embodiment of the questionnaire in accordance with the invention;

FIGS. 15A-I are diagrams illustrating an example of a preferred embodiment of an image database that is part of the on-line design process in accordance with the invention;

FIG. 16 illustrates an example of the design process in accordance with the invention;

FIG. 17 is a screen shot of an example of a site plan design process in accordance with the invention;

FIG. 18 is a screen shot of an example of a hardscape plan design process in accordance with the invention; and

FIG. 19 shows the user design experience in accordance with the invention.

### DETAILED DESCRIPTION OF A PREFERRED EMBODIMENT

The invention is particularly applicable to a web-based on-line design system and method and it is in this context that the invention will be described. It will be appreciated, however, that the system and method in accordance with the invention has greater utility since the on-line design system can be implemented using other computer-based technologies and architectures that are within the scope of the invention.

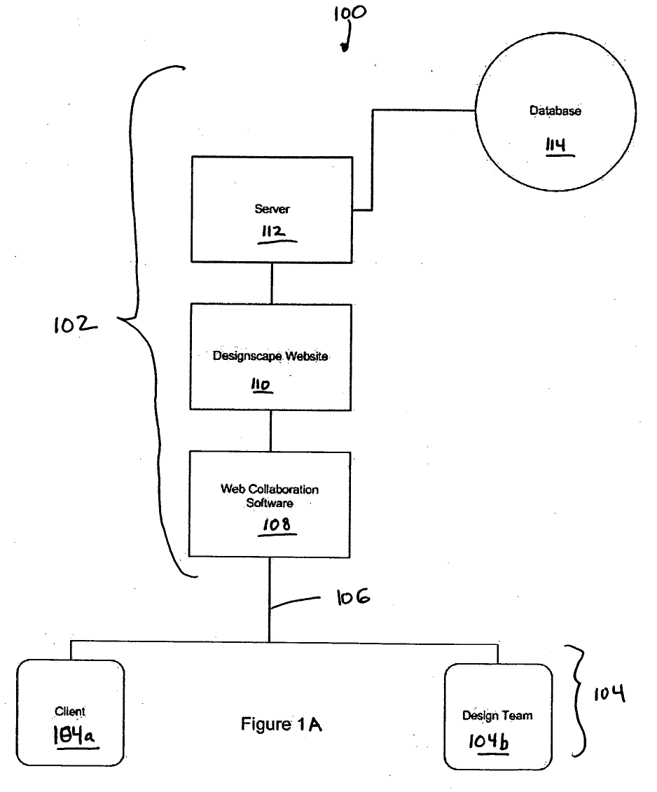

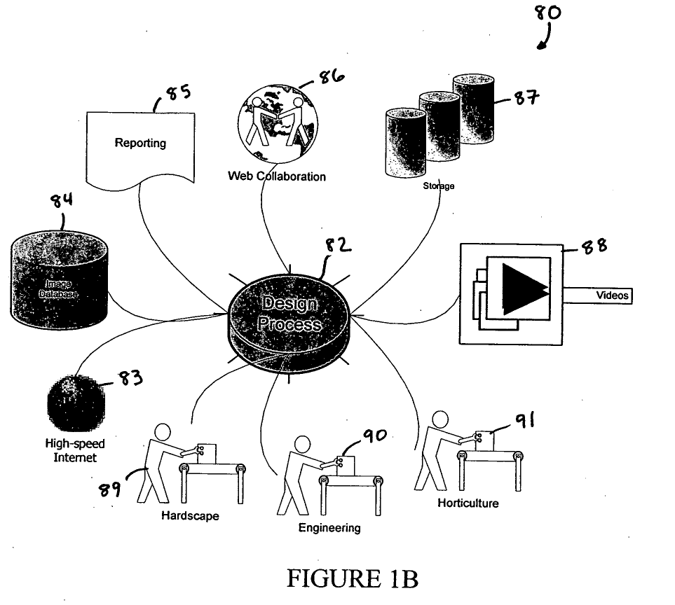

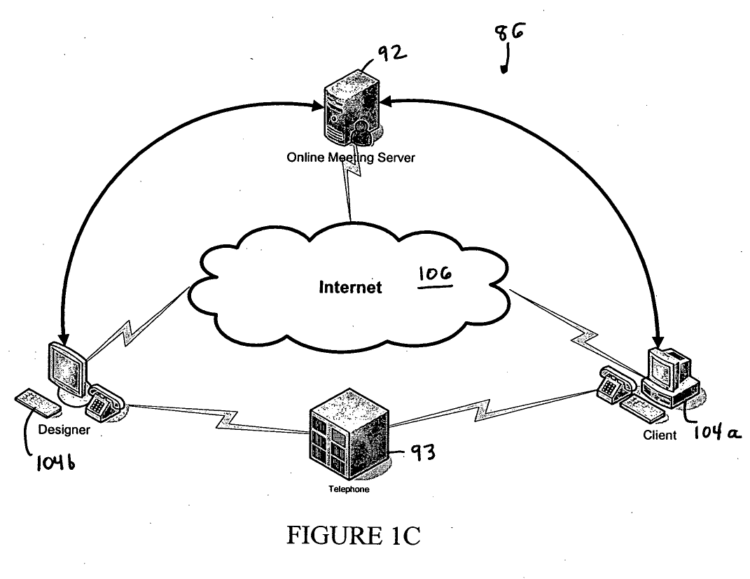

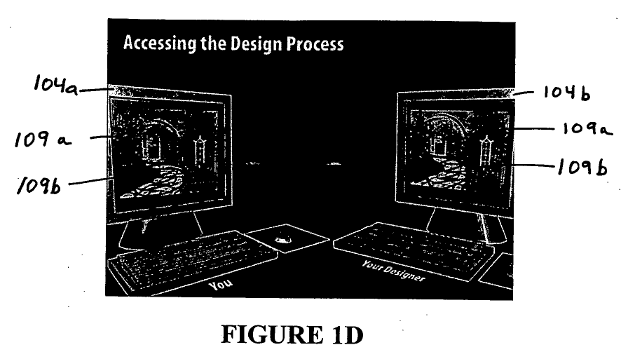

FIG. 1A is a block diagram illustrating a web-based on-line design system 100 in accordance with the invention. The system may include a design system 102 that is connected to one or more participants 104, such as a client 104a and a design team 104b over a communications network 106 such as the Internet, intranet or other computer network. The client 104a and design team 104b may each utilize a computer system to interact with the design system in accordance with the invention. Each client computer requires at least a processor, some memory, a persistent storage device and a device to access the communications network 106 so that it can exchange data with both the design team and the system 102. The system permits the user and the design team to collaborate to create a design and design plans. The design generated by the system in accordance with the invention may include landscape designs, interior designs, remodel designs and the like since the invention is not limited to any particular type of design project. For purposes of illustration, an on-line landscape design system is illustrated and described, but the invention is not so limited. The on-line design system reduces the time required to produce and implement a particular design and provides more interactive cooperation and collaboration between the design team and the client which results in a more satisfied client and a design that requires less reworking and changing. Generally, the system 102 generates various information and data that is shared between the client 104a and the design team 104b using a web collaboration tool 108 that may be a piece of software in a preferred embodiment. The collaboration tool permits the client and the design team to work collaboratively together on the design. A well known web collaboration tool that may be used with a preferred embodiment of the system may include the WebEx® system that is further described at www.webex.com/, the commercially available Microsoft® Live Meeting tool or the commercially available Go to Meeting tool. The on-line design system 100 also has a website 110 that generates web pages and receives data/input from the user or design team. The system also has a main computer 112, such as a server computer in a preferred embodiment, that controls the overall operation of the design system. The main computer 102 stores the various data in the system in a storage unit 114, such as a database. The main computer is a typical computer system with at least one processor, memory and some form a persistent storage device, that executes one or more pieces of software, software modules, etc. to implement the functions and processes of the design system that are described in more detail below.

FIG. 1B illustrates a design system 80 that incorporates a design process 82. The design process 82 incorporates one or more elements that are integrated together to form the on-line design process in accordance with the invention. These elements may include a network connection 83, an image database 84 containing images that may be used during the design process, a reporting module 85, a web collaboration tool 86, a storage unit 87 for storing the data associated with each design project as well as other data, a video module 88, and access to one or more specialists that assist the client with the design project and process. In the example of the landscape design system, the specialists may include a hardscape designer 89, an engineer 90 and a horticulturalist 91. The on-line design system in accordance with the invention permits each client to have direct access to these experts at the appropriate stage of the design process. Thus, the client may have access to, in the example of the landscape design process, a landscape designer, a horticulturalist and an engineer either telephonically, in person or using the collaborative tools of the system. For a different design process, such as interior design, the system may provide the user with access to experts that have skills pertinent to the particular design process.

FIG. 1C illustrates more details of the web collaboration tool 86 that may be used with the on-line design system. The web collaboration tool connects the client 104a and the designer 104b over the network 106 using a telephone system 93 and an online meeting server 92. The web collaboration permits the client to collaboratively interact with the experts. For example, during the hardscape design process as described below in more detail, the designer may display the current draft of the hardscape design plan to the client using the web collaboration tool as shown in FIG. 1D wherein an image of the proposed design plan is simultaneously displayed on both the client computer 104a and the designer computer 104b. Then, either the user or the designer can electronically mark up the image (see marks 109a and 109b) wherein the electronic mark ups are displayed on both computers as shown. Thus, the designer and client both see any edits/modifications to the plans in real-time and can approve those edits/modifications so that the design process time is shortened since any modifications are done in real-time. In addition, the designer is able to immediately and interactively offer suggestions about the modifications or propose other design options. Thus, using the web collaboration tool of the on-line design system, a finalized design plan is achieved more rapidly.

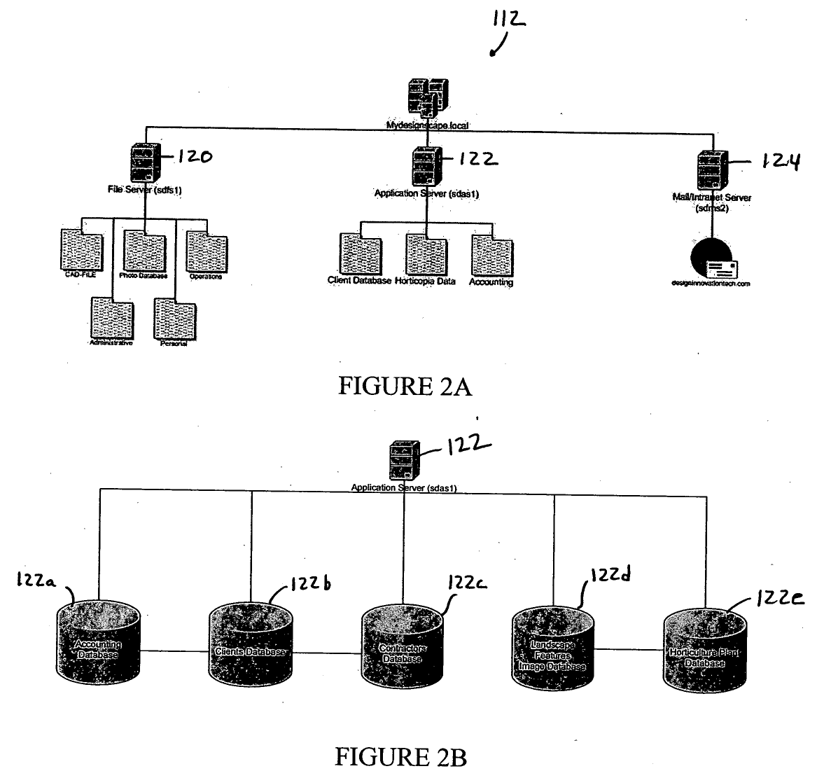

FIG. 2A is a diagram illustrating more details of the main computer 112 shown in FIG. 1. As shown, the main computer may include a file server 120, an application server 122 and a mail/intranet server 124. The file server may store one or more files used by the design system such as CAD files, photograph databases, operations data, administrative data and personal data. The application server 122 may store data such as client database data, horticultural data and accounting data while the mail/intranet server 124 may host the website. FIG. 2B is a diagram illustrating more details of the application server 122. The application server in the exemplary landscape design system may include an accounting database 122a, a clients database 122b, a contractor database 122c, a landscape and features image database 122d and a horticulture plant database 122e.

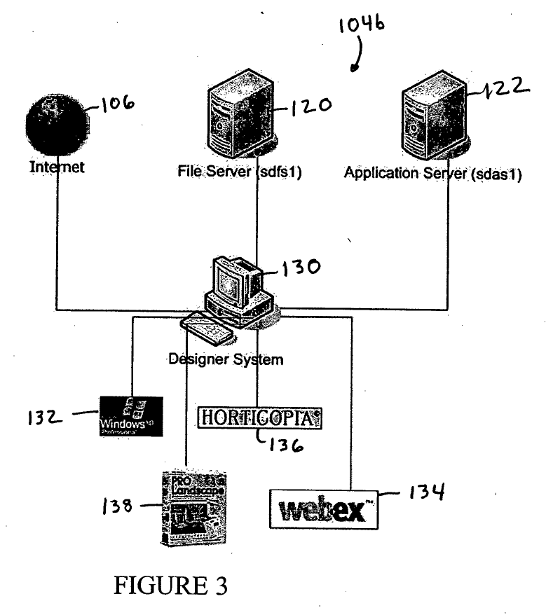

FIG. 3 is a diagram illustrating more details of each design team computer 104b. In particular, each member of the design team may have a computer system 130 that has sufficient processing power, memory and storage to interact with the communications network 106, the file server 120 and the application server 122 as well as to execute one or more pieces of software, such as for example, an operating system 132, a collaboration tool 134, a horticulture tool 136 and a landscaping tool 138 when the design system is being used to develop a landscape design. The actual software tools shown in FIG. 3 are merely illustrative as the present invention may be used with various different collaboration tools, horticulture tools or landscaping tools.

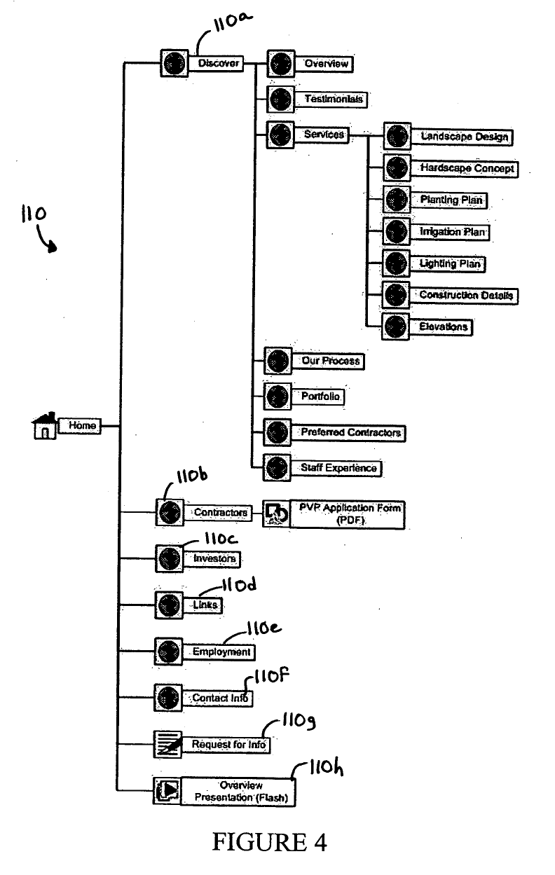

FIG. 4 is a diagram illustrating an exemplary layout for the website 110 shown in FIG. 1. The website has one or more web pages, such as a discover page 110a, a contractors page 110b, an investors page 110c, a links page 110d, an employment page 110e, a contact info page 110f, a request for info page 110g and an overview page 110h. The contact info page 110f provides a client/user with access to the client design center as well as access to the on-line design system. For purposes of the functionality of the on-line design system in accordance with the invention, the discover page 110a and the contractors page 110b are important. In particular, the contractors page 110b permits a design contractor, such as a landscape design contractor in this exemplary embodiment, to become part of a preferred vendor program (PVP). The PVP permits the on-line design systems to offer its clients referrals to pre-qualified contractors that can build the designs generated by the system. For the contractors, the system will send out each newly completed design to a subset of the contractors so that those subset of the contractors have a first chance to bid on the design project. Using the preferred vendor program, the owner of the on-line design system is able to gain additional revenue from the on-line design process based on the referrals that occur through the preferred vendor process. The discover page 110a permits a potential new client to learn about the on-line design system in accordance with the invention.

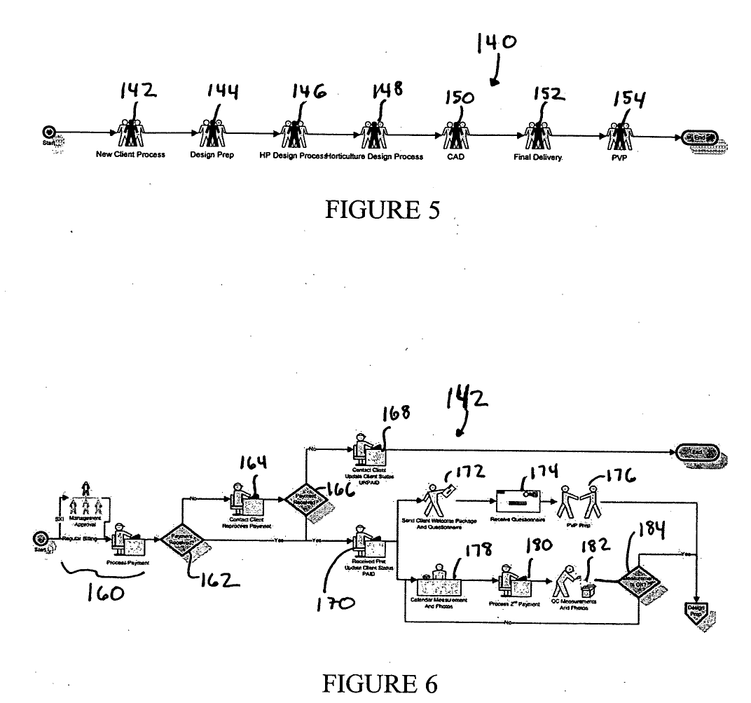

FIG. 5 illustrating an on-line design method 140 in accordance with the invention. The method may include one or more processes that, when combined together, form the overall on-line design method. The method is preferably implemented using a computer system that executes software to implement the processes. The method 140 may include a new client process 142 in which a new client is signed into the system so that information about that customer is stored in the storage unit 114 shown in FIG. 1, a design preparation process 144 in which initial steps for the design process are completed with a collaborative effort of the design team and the client, a hardscape plan design process 146 in which the hardscape plan of the landscape design is done with a collaborative effort of the design team and the client, a horticulture design process 148 in which the horticulture of the landscape design is done with a collaborative effort of the design team and the client, a CAD process 150 in which the computer generated representations of the landscape design plans are generated, a final delivery process 152 in which the design is finalized with the client and a hardcopy of the design documents is generated and a PVP process 154 in which the finalized design is referred out to a select group of contractors that are able to bid for the design project. As described above, these are the processes when the exemplary landscape design system is being implemented. However, the on-line design method would have other processes not shown in FIG. 5 when, for example, an on-line remodeling system is being implemented and those other processes for the other types of design systems and methods are within the scope of this invention. For example, for the remodeling on-line design system, the processes may include a demolition process, a structural design process, and the re-design process. As another example, during the on-line interior design process, it may include a removal process to remove the existing furniture and furnishings and a color process to design the new color scheme for the space.

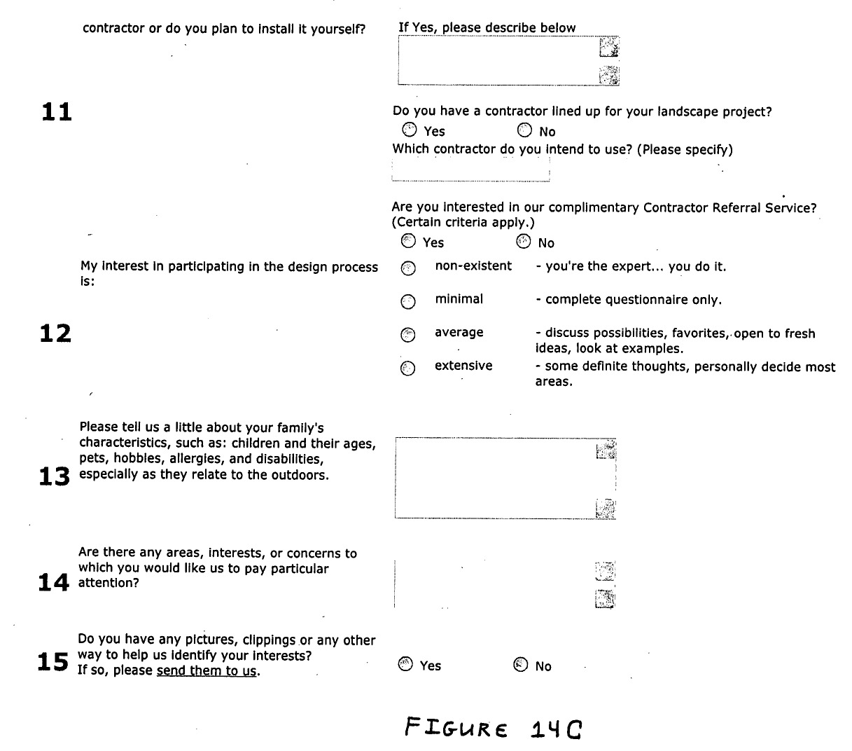

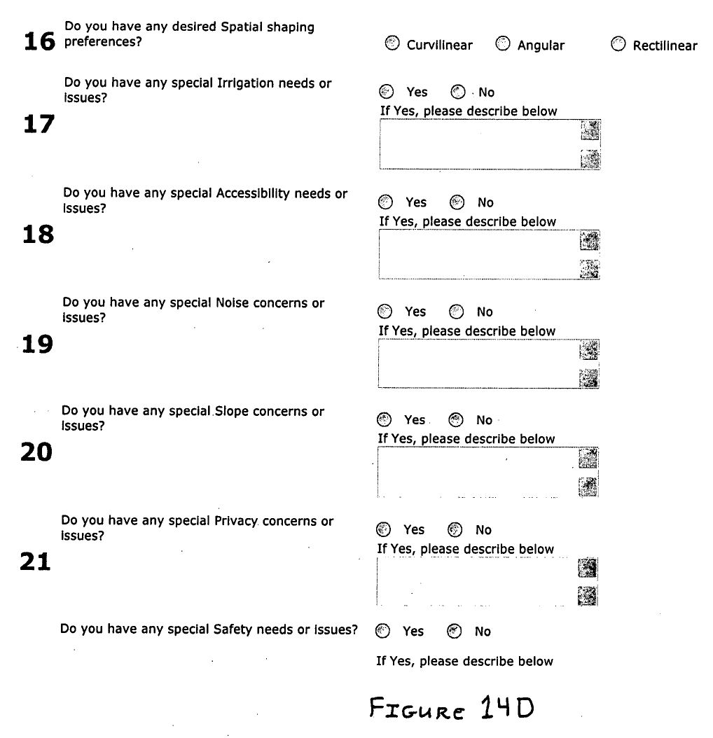

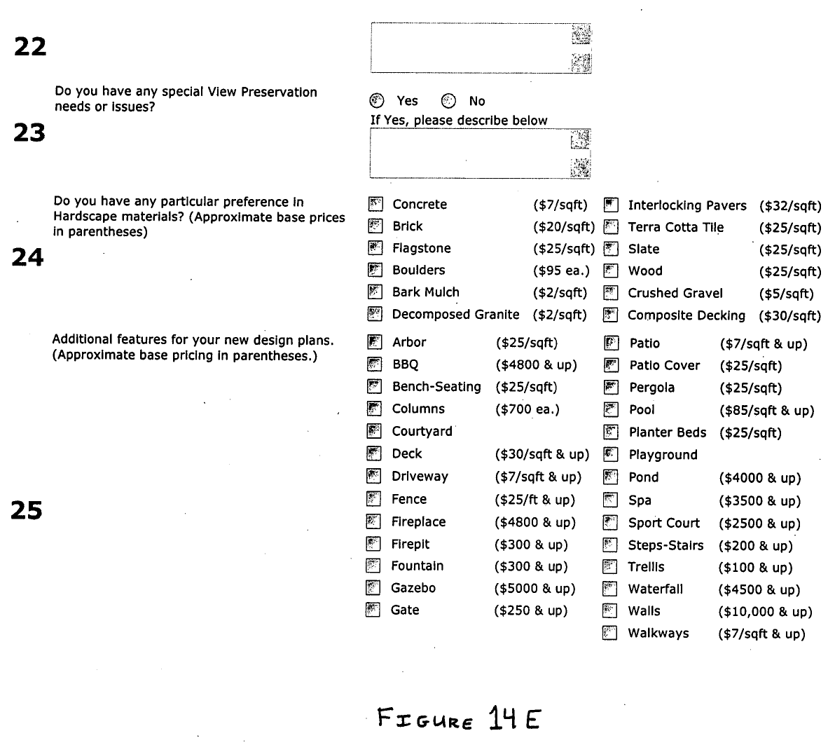

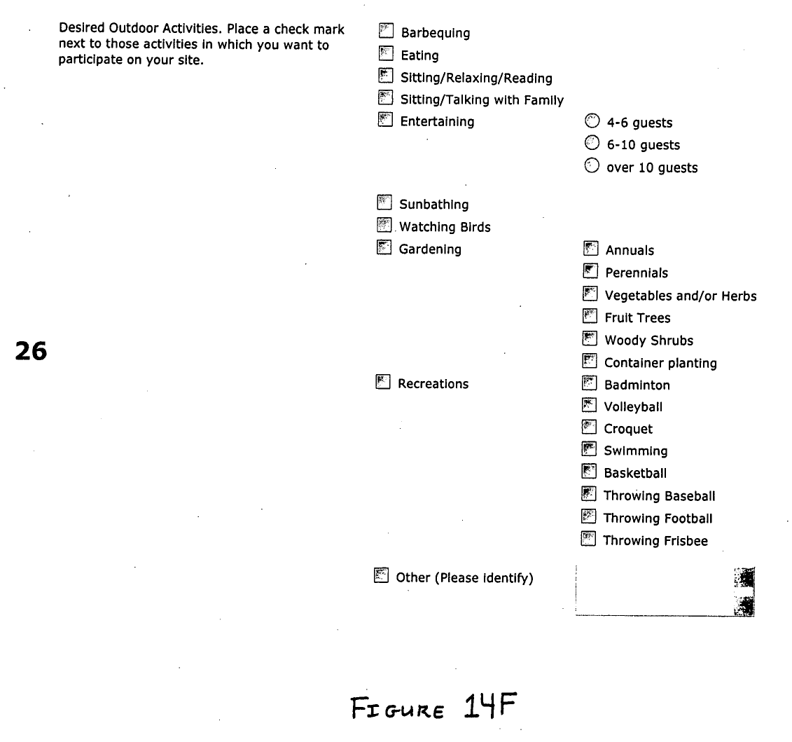

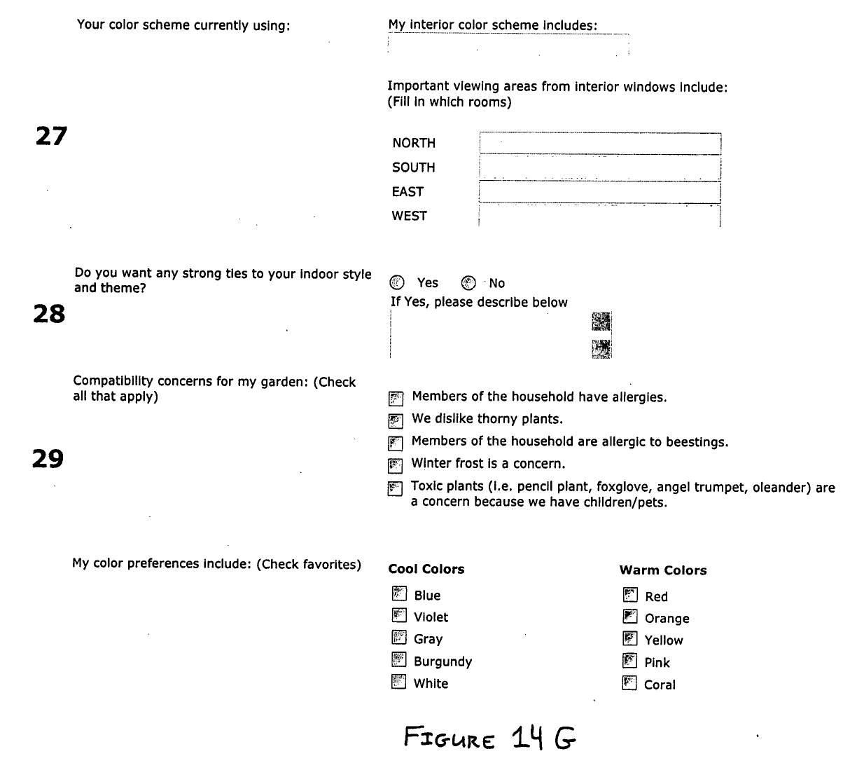

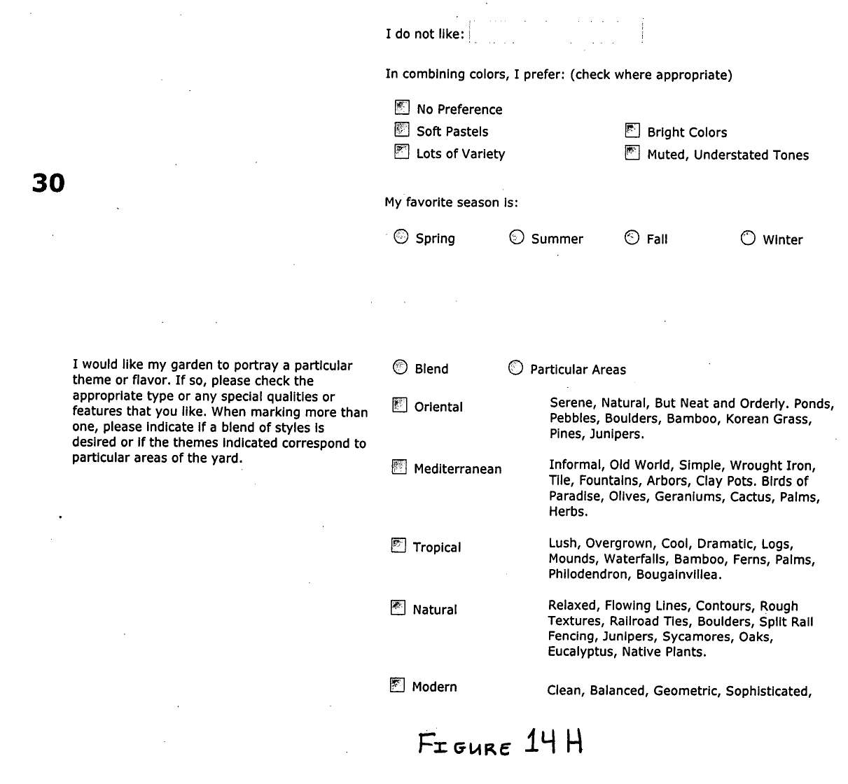

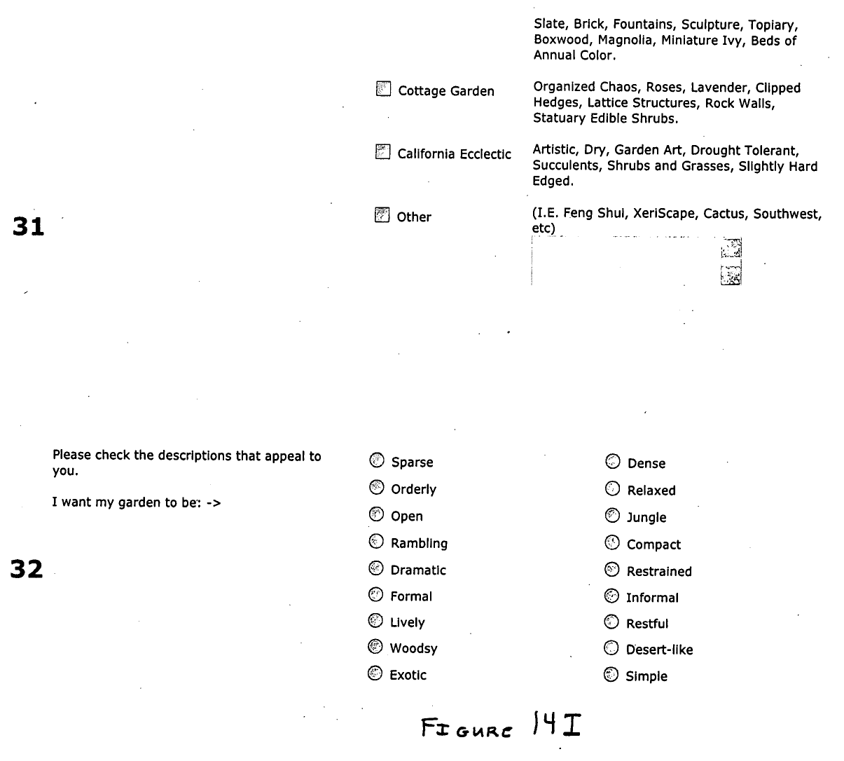

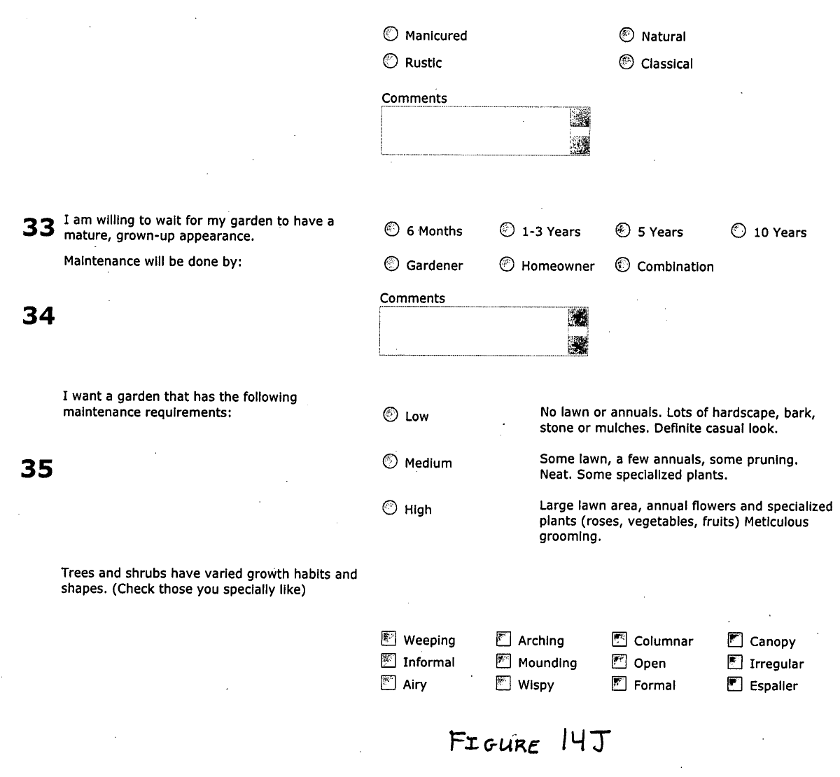

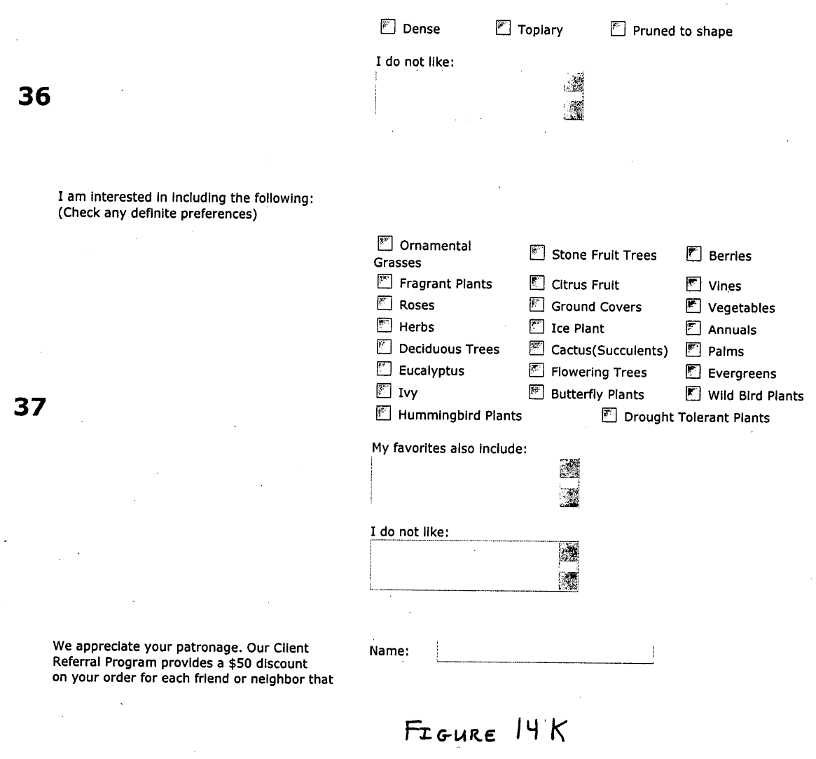

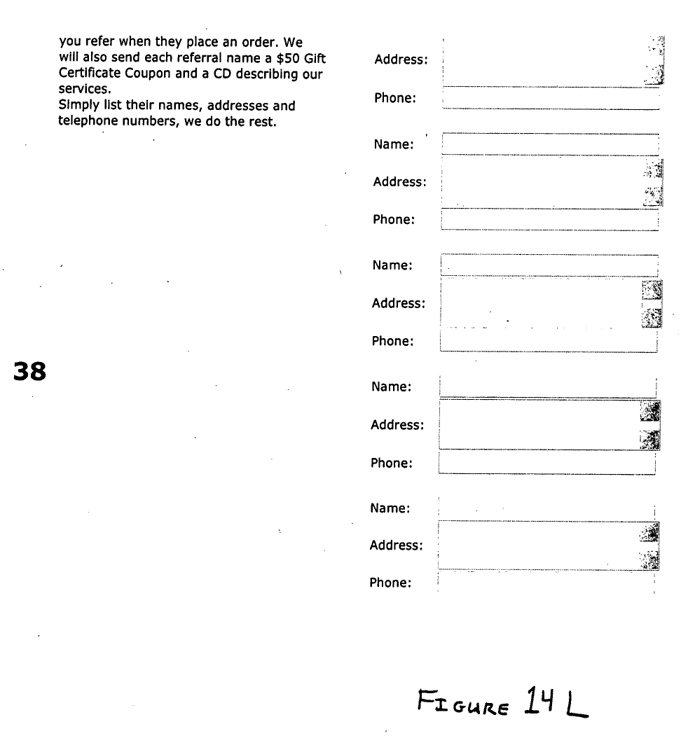

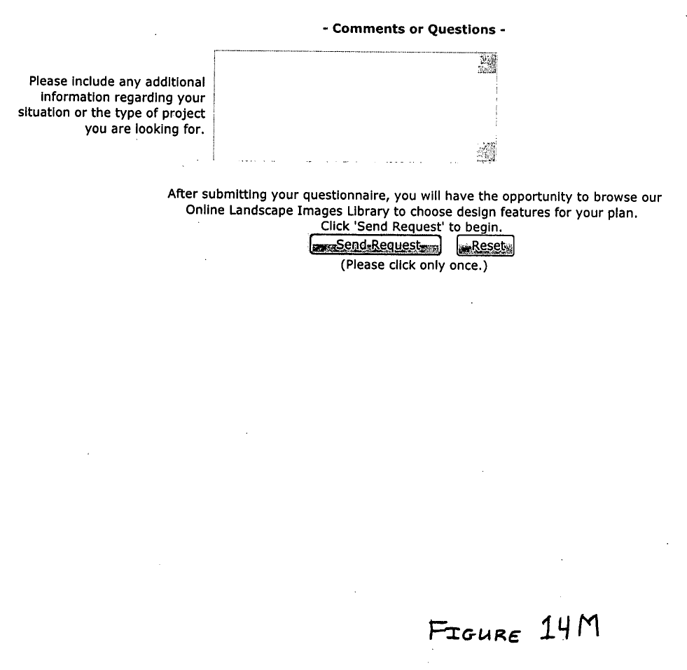

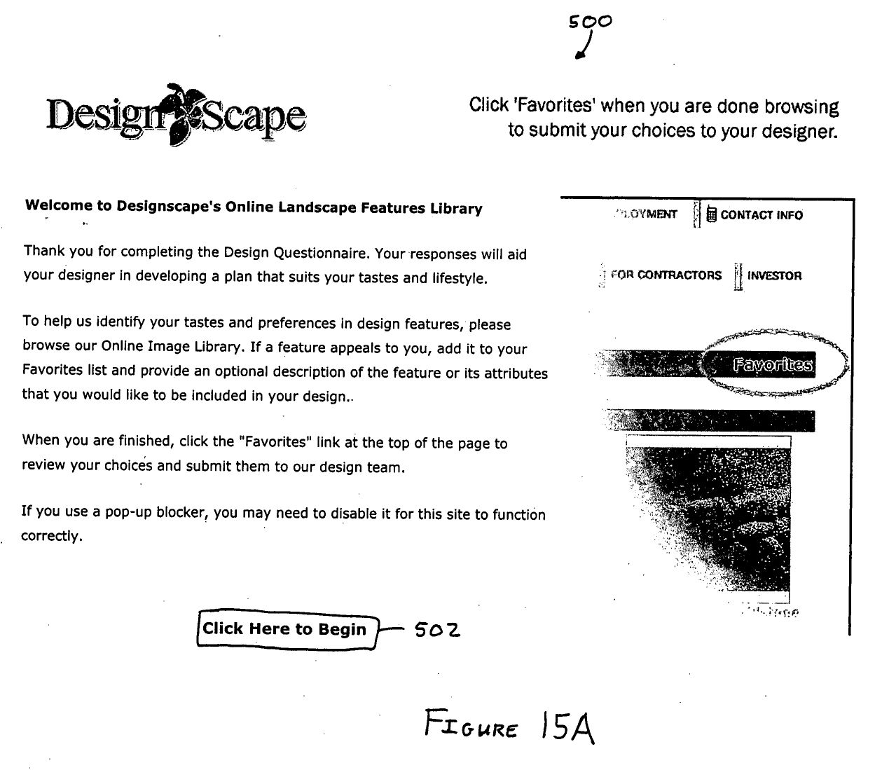

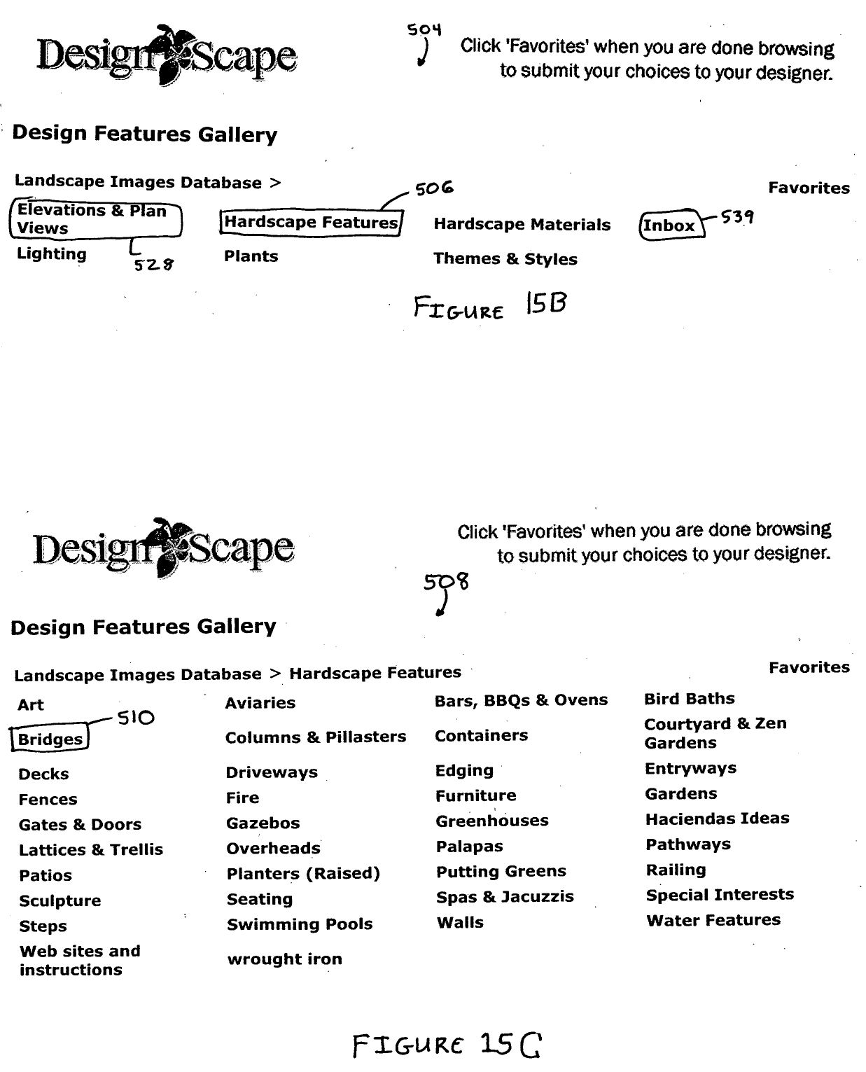

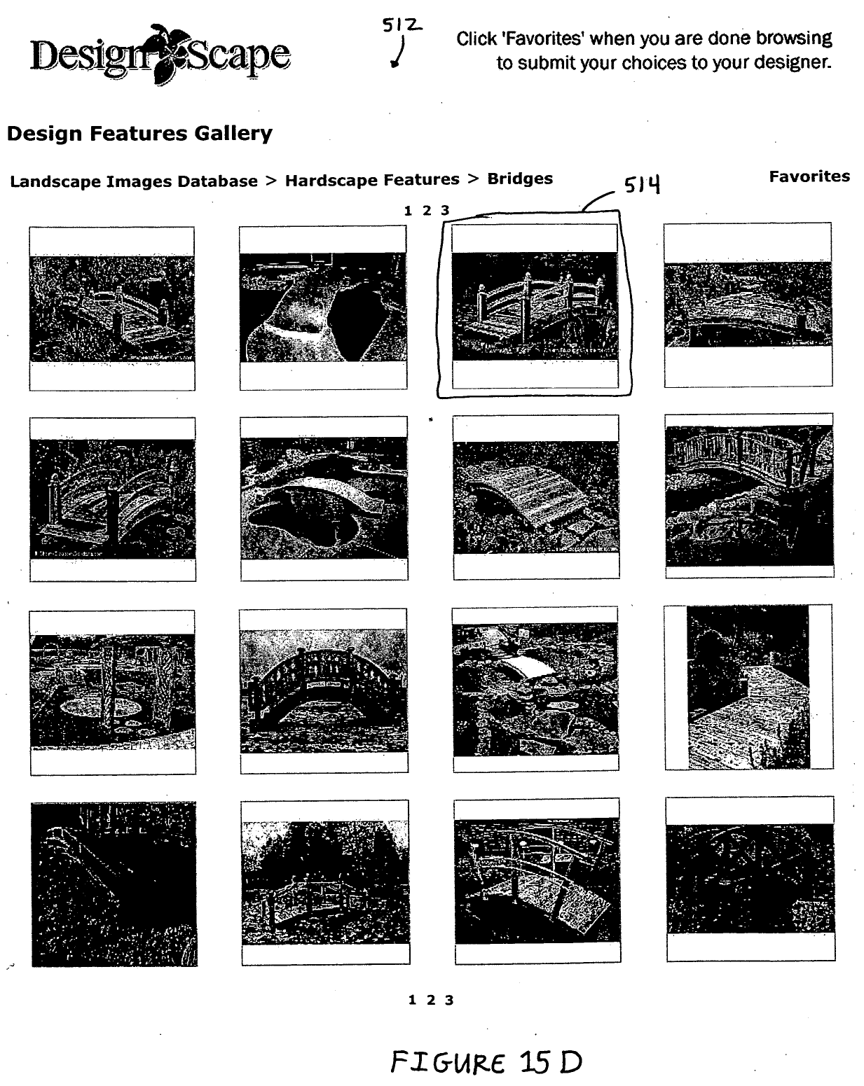

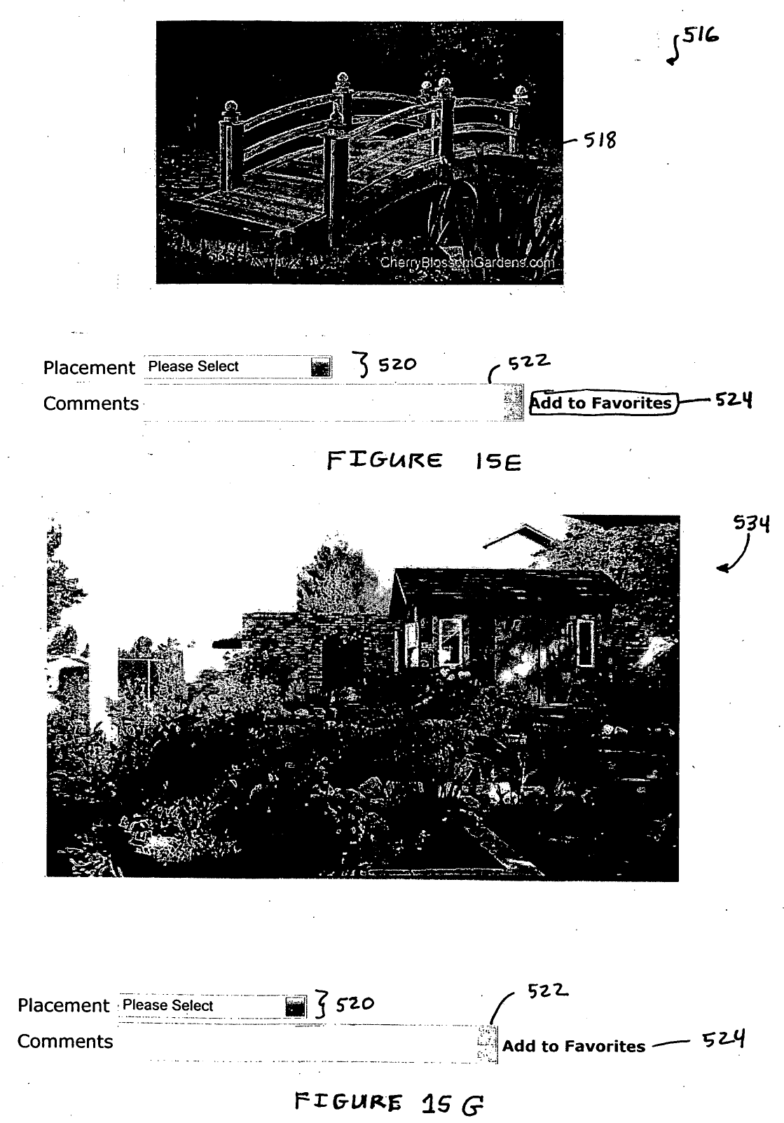

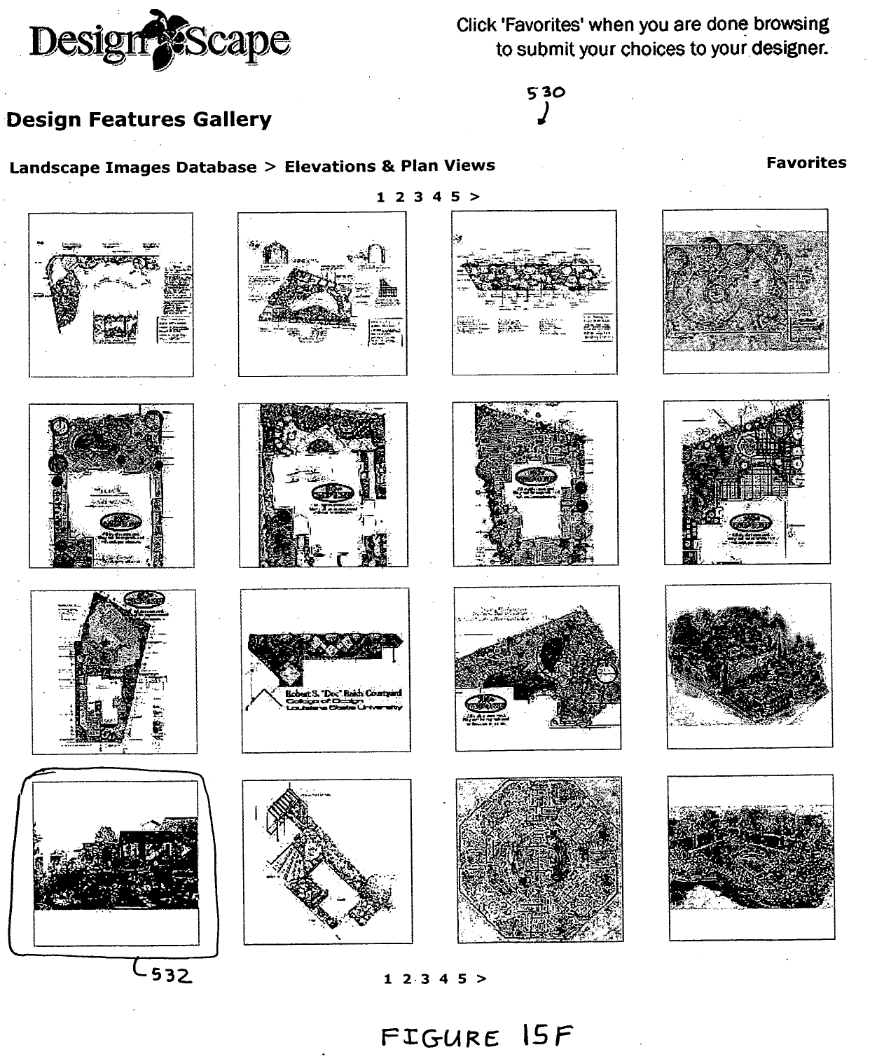

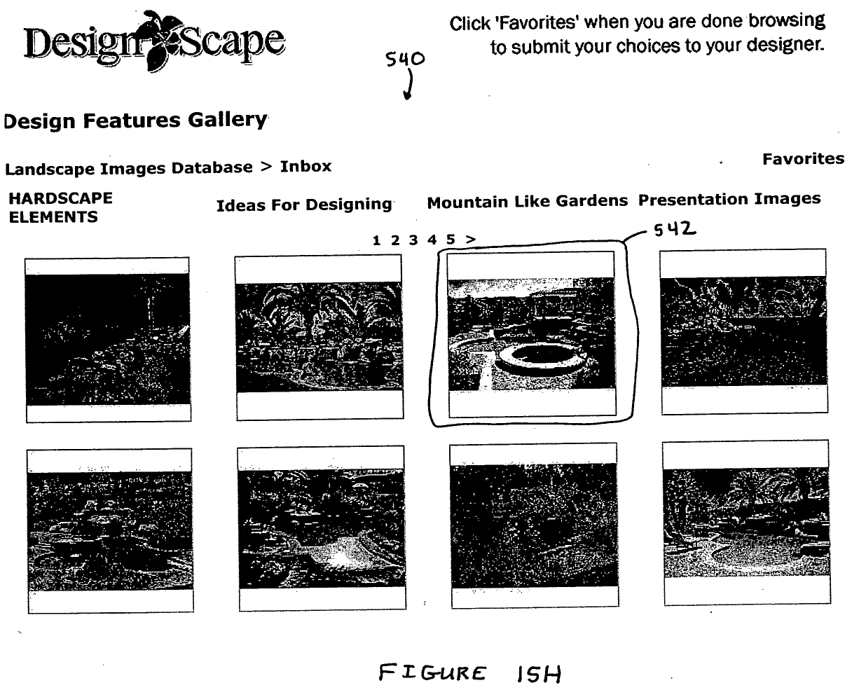

FIG. 6 illustrates more details of the new client process 142 shown in FIG. 5. In step 160, the initial payment of a client is processed. Prior to this step, the system will obtain various information about the client that is entered in the storage unit. In step 162, the system determines in the payment has been received. If the payment has not been received, then in step 164, the system alerts an accounting person that is able to follow up with the client. After the follow-up, the system in step 166 determines if the payment has been received after the follow up. If the payment has not been received, then in step 168, the system updates the client status to “unpaid” and the new client process is completed. Returning to step 162 and 166, if the payment of the client has been received, then in step 170, the client status is changed to “paid. In step 172, the client is sent a welcome package and questionnaire and the system processes the questionnaire in step 174 and performs preparation in step 176 for the PVP process. The questionnaire asks for various information from the user including design choices and location of different design aspects in the overall design using an image database. An example of a preferred embodiment of a questionnaire and an example of a preferred embodiment of the image database are described in more detail below with reference to FIGS. 14 and 15. In step 178, a time to measure the property and take photographs of the property is scheduled. In step 180, the second part of the payment of the client is processed. In this preferred embodiment, the total cost of the design process is separated into four portions so that the client pays for each portion of the design process as it is completed. In step 182, a member of the design team quality checks the measurements and photographs obtained. In step 184, if the measurements and photographs are not acceptable, the method returns to step 178 so that the measurements and photographs can be taken again. Otherwise, the new client process is completed and the design preparation process begins.

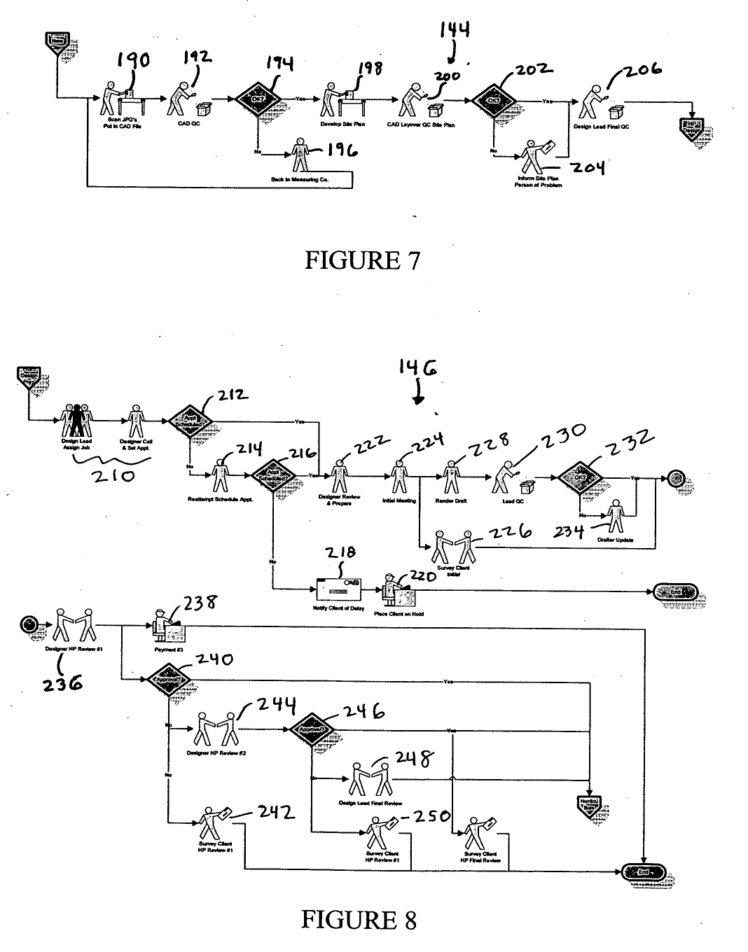

FIG. 7 illustrates more details of the design preparation process 144 shown in FIG. 5. In step 190, a member of the design team scans the photographs, converts them into JPEG files and places them into a CAD file using the measurements for the client. These photographs are then used during the design process. In step 192, the CAD file is quality checked and it is determined if the CAD file is acceptable in step 194. If the CAD file is not acceptable, then in step 196, the process returns to obtaining new measurements and photographs of the client property. If the CAD file is acceptable, then a site plan is developed in step 198 by the collaborative effort of the client and the design team wherein the design team prepared a first draft of the site plan and then reviews that draft site plan with the client using the collaborative web tool described above. In steps 200 and 202, the site plan is quality checked and any problems are forwarded into the site plan member of the design team in step 204. If the site plan is acceptable, then in step 206, the lead designer performs a final quality check on the site plan and then the design preparation process is completed and the hardscape plan design process is commenced.

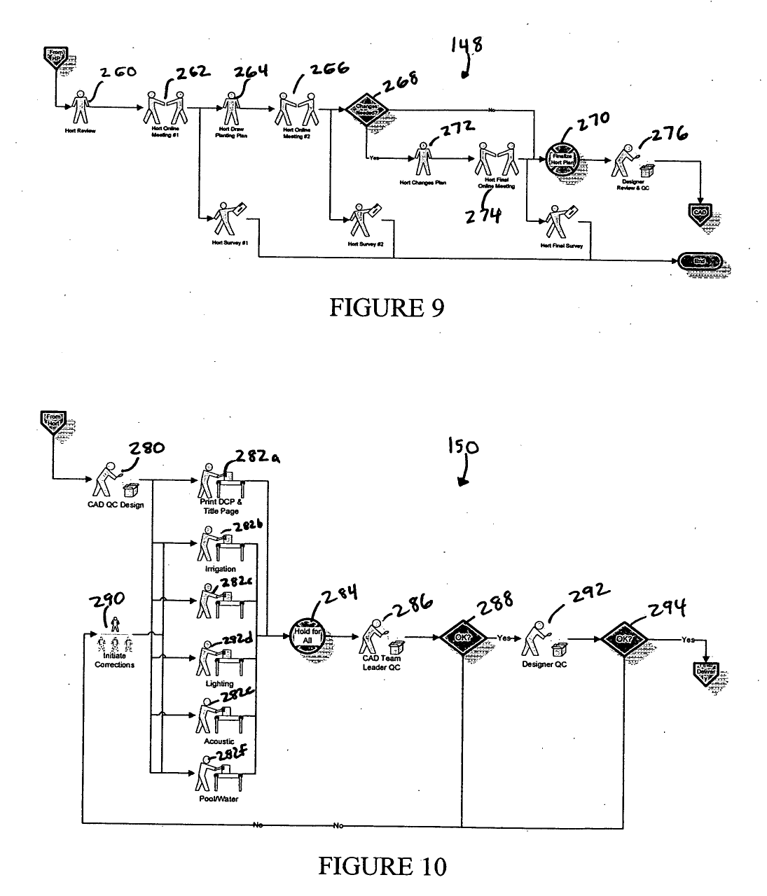

FIG. 8 illustrates more details of the hardscape plan design process 146 shown in FIG. 5. In step 210, a design leader assigns the job to a team member who calls to set up an appointment. In step 212, the system determines if the appointment has been scheduled and reattempts to schedule the appointment in step 214 and checks if the appointment is scheduled in step 216. If the appointment is still not scheduled, then in step 218 the system notifies the client of the delay and in step 220 places the client project on hold. If the appointment has been scheduled, then in steps 222 and 224, the designer reviews the project and prepare for and has the initial meeting with the client. In step 226, the initial survey of the client's design project is completed. Alternatively, in steps 228, 230, 232 and 234, a draft is generated that is then quality checked and then redrafted if edits are needed. In step 236, the design hardscape plan review occurs. In step 238, a third payment of the client is processed. In step 240, the client's approval of the hardscape plan is determined using the collaborative tool described above. If the client approves of the hardscape plan plan, then the method moves onto the horticulture process that is described below with reference to FIG. 9. If the client does not approve the hardscape plan design, then a client review is performed in step 242 using the collaborative tool or a second designer hardscape plan review in started in step 244. In step 246, the system determines if the client approves and goes to the horticulture design process if there is an approval. If there is not an approval, then either there is a final review by the lead designer in step 248 or a client survey is performed in step 250.

FIG. 9 illustrates more details of the horticulture design process 148 shown in FIG. 5. In step 260, the horticulture for the project is reviewed and an initial on-line meeting between the client and horticulture specialist occurs in step 262 using the collaborative tool described above. In step 264, the horticulture specialist, using the information from the on-line collaboration with the client, generates a horticulture plan which is then reviewed at a second on-line meeting in step 266 using the collaborative tool described above. In step 268, the horticulture specialist and the client decide if any changes are needed. If no changes are needed, the horticultural plan is finalized in step 270. If changes are needed, then the horticulturalist changes the plan in step 272 and a final on-line meeting between the horticulturalist and the client occurs in step 274 so that the plan is finalized. In step 276, a designer performs a review and a final quality control review of the horticulture plan and this process is then completed.

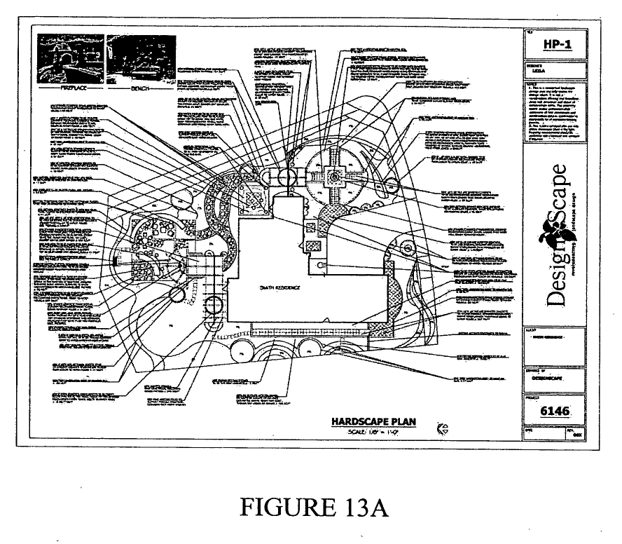

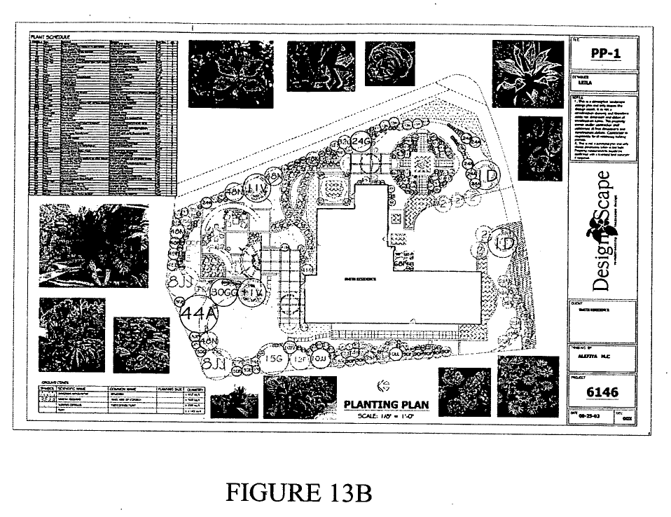

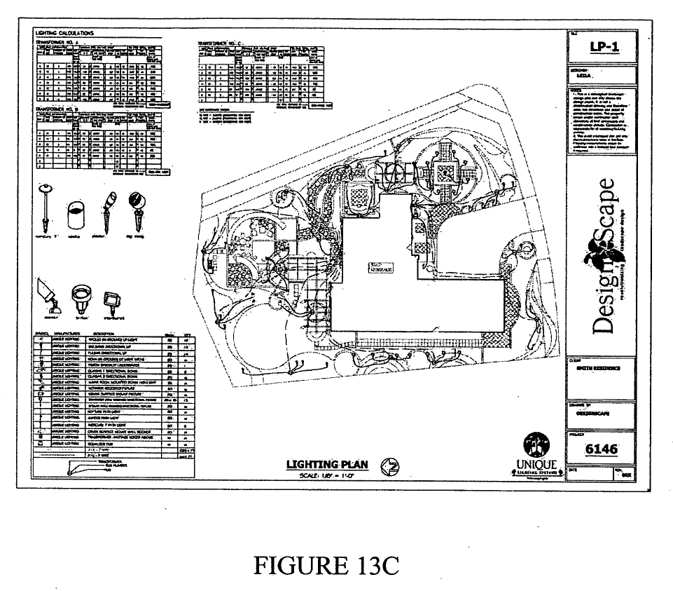

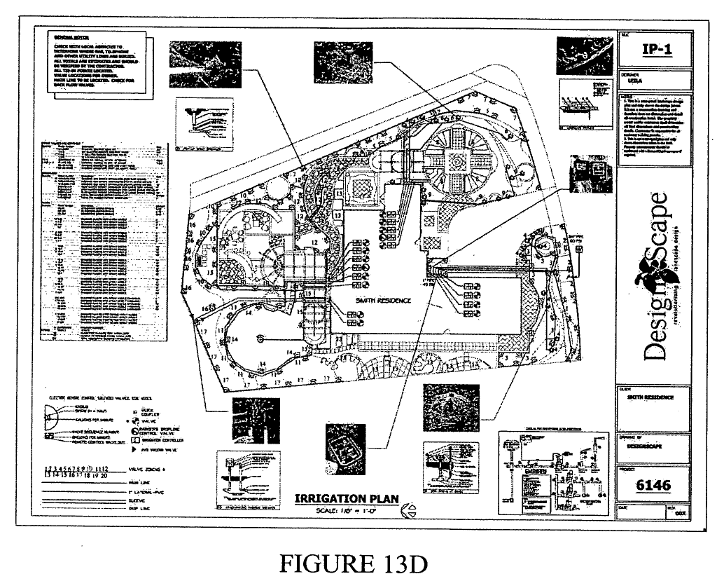

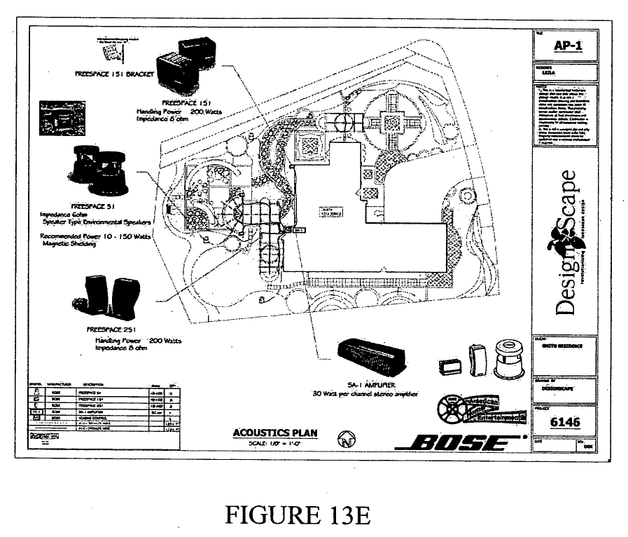

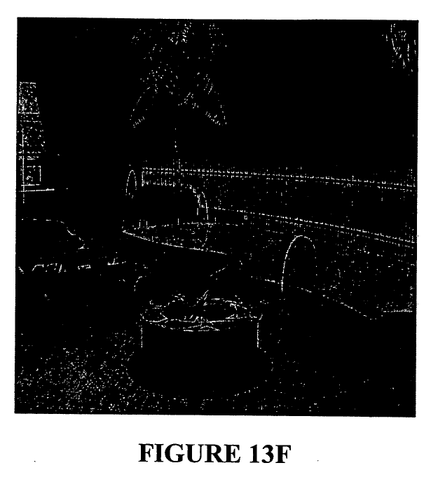

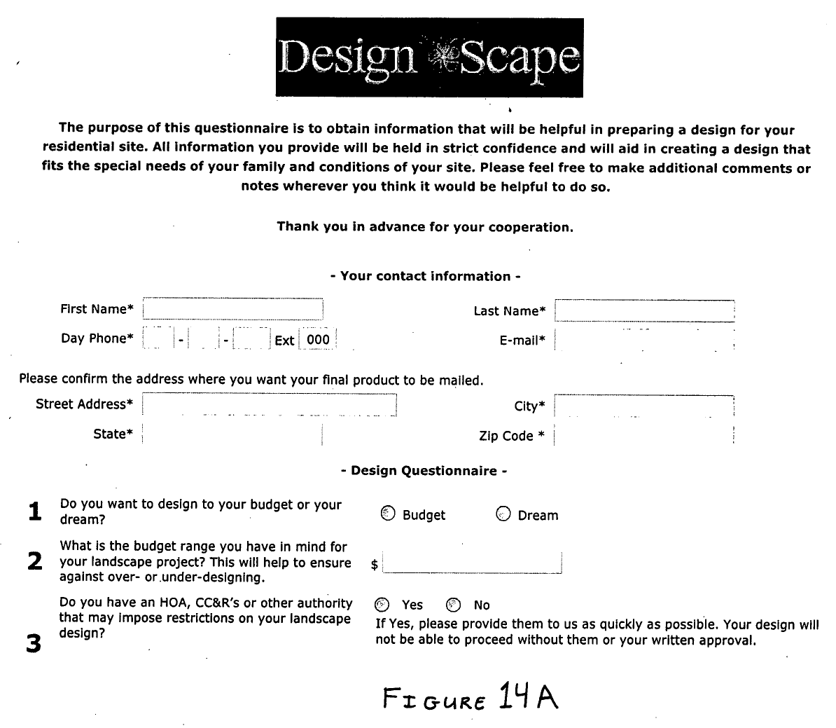

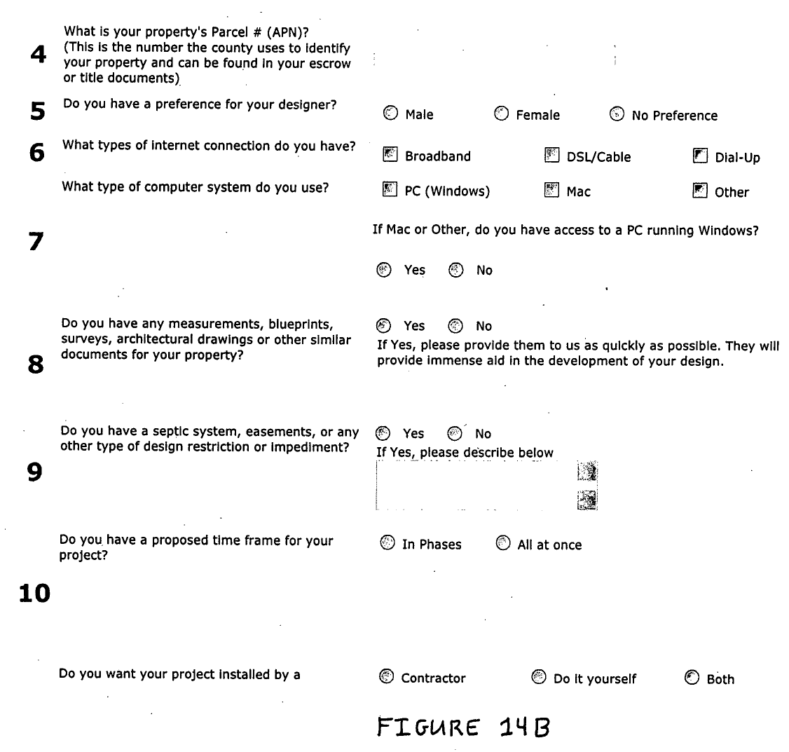

FIG. 10 illustrates more details of the computer aided design (CAD) process 150 shown in FIG. 5. In step 280, a CAD designer performs a preliminary quality control step and then one or more sub-processes 282 are performed in parallel. The sub-processes for this landscape design embodiment include printing a title page 282a, an irrigation CAD design 282b, an elevations CAD design 282c, a lighting CAD design 282d, an acoustic CAD design 282e and a pool/water CAD design 282f. In the elevation design process, the other design plans generated by the system are used to generate a 3-D computer generated elevational view of the overall design plan such as is shown in FIG. 13F. The system then waits in step 284 until all of the CAD sub-processes have been completed. When all of the sub-processes have been completed, the CAD team leader quality checks the designs in step 286 and determines if the design is acceptable in step 288. If the CAD design is not acceptable, then an initiate corrections step 290 is performed which may include one or more of the sub-processes 282a-f. If the CAD design is acceptable then the project designer does another quality check in steps 292 and 294. The CAD design process is then completed.

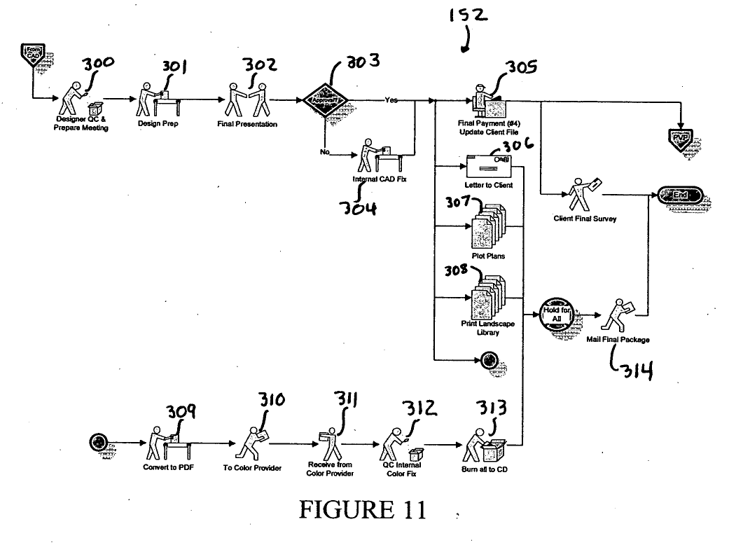

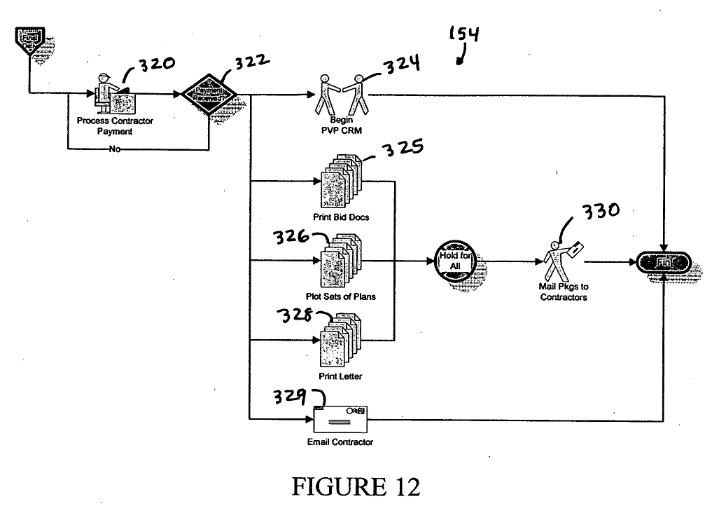

FIG. 11 illustrates more details of the final delivery process 152 shown in FIG. 5. In step 300, the designer does a quality check of the materials and prepares for a final meeting with the client. In step 301, any final design preparation is performed. In step 302, a final presentation to the client of the project design is performed to determine if the client approves of the project design in step 303. If the project design is not approved, then any CAD file changes are performed in step 304. Once the project design is approved, a final fourth payment in step 305 is made and the client file is updated. The client file is forwarded onto the PVP process described in more detail in FIG. 12. The system may also generate a client letter in step 306, plot plans 307 and print landscape libraries in step 308. At the same time, the system may also convert the project plan into a PDF in step 309, send to the color provider in step 310, receive the project back in step 311, perform internal quality checks on the color prints in step 312 and burn the project design plans onto a CD in step 313. When these steps are completed, the entire design package is mailed to the client in step 314.

FIG. 12 illustrates more details of the PVP process 154 shown in FIG. 5 in which the design plans of a completed project are circulated to a set of pre-approved contractors that may then bid on the design project. Thus, in accordance with the invention, the system provides the client with more rapidly produced design plans as well as a referral network to contractors. In step 320, a payment of the contractor is processed and checked in step 322. If the contractor payment has been received (indicating that the contractor would like to receive a copy of this design plan, then a PVP CRM process 324 occurs. In addition, bid documents are printed in step 325, a set of plans are generated in step 326, a letter is printed in step 328 and an email is sent to the contractor in step 329. In step 330, the project design package is sent to the contractors. The PVP process is beneficial to all parties. For the contractors, they know that they will receive a well thought out and design plan which makes the bidding process easier as the contractor knows that the plan is pre-screened. The client, they have access to a set of pre-screened and qualified contractors.

FIGS. 13A-F are examples of the design plan generated by the system in accordance with the invention. In particular, the various design processes described above may generate a set of design plans that may include a hardscape concept plan shown in FIG. 13A, a planting plan design shown in FIG. 13B, a lighting plan design shown in FIG. 13C, an irrigation plan design shown in FIG. 13D, an acoustics design plan as shown in FIG. 13E and an elevational view as shown in FIG. 13F. In this manner, the end result of the on-line design process and system in accordance with the invention is a set of plans that satisfy the client and permit the client to easily get and accept bids for the construction of the design project since a complete set of plans and designs such as those shown in FIG. 13A-F are generated by the system. The hardscape is an industry term for everything in the project that is made of stone, concrete, or brick. The hardscape plan shown in FIG. 13A details all of the hardscape that is part of the design project that may include for example, concrete, stone pathways, mow curbs, retaining walls, pillars, etc. The hardscape plan also includes the types of treatment on concrete, such as broom finish, stamped or colored concrete. Once the hardscape plan is completed, the system is able to compute the square footage and linear footage of all of the elements of the hardscape as well as the estimated cost of the hardscape plan that may then be used by contractors to prepare the bids. Similarly, for the planting plan, lighting plan, irrigation plan and acoustics plan, the system also calculates the estimated costs of each plan so that the client as well as the contractor can estimate the cost of each plan and of the overall design plan. When the system is implemented for other design projects, such as interior design and the like as described above, the system calculates the estimated costs of the plans for those other design projects.

The planting plan shown in FIG. 13B identifies all of the plants, trees, flowers, shrubs, grass, etc of the landscape design. A good planting plan is important for the long term health of the landscape since it is important to identify which plants do well in sunny areas and which plants do well in shady areas. The plants, etc. in the planting plan are laid out using symbols in the plan to identify the placement of the plants in the property in the plan. The plan may also include a plant legend that describes each of the symbols so that the plant legend lists the symbols, common plant name, scientific name, size and quantity of every plant, tree and shrub listed in the planting plan. The planting plan makes it easy for a contractor to quickly bid on the design project by obtaining pricing through the plant legend at a local nursery. The irrigation plan shown in FIG. 13D identifies the details required for the proper irrigation construction. The irrigation plan thus identifies the areas that require heavy irrigation and areas that require less irrigation to delivery the proper moisture to the entire landscape. The irrigation plan may include drip systems, valve controllers and the identification of proper spray heads. The irrigation plan also may include a bill of materials that lists the length of pipe required by the design, each valve and each spray head.

The lighting plan shown in FIG. 13C show the lighting for the design. The lighting plan shows the location of the various lighting of the design, such as low voltage lights etc., as well as a bill of materials that lists all of the elements required for the lighting plan so that a contractor can easily bid for the lighting portion of the design project. The acoustics plan, shown in FIG. 13E, shows the location of the various acoustic components of the design, such as speakers etc, as well as a bill of materials that lists all of the elements required for the acoustic plan so that a contractor can easily bid for the acoustic portion of the design project.

FIG. 14A-14M are an example of an embodiment of the questionnaire in accordance with the invention. The screen shots shown in FIG. 14A-14M show the variety of questions that are completed by the user. In accordance with the invention, these questions (along with selections from the image library shown in FIGS. 15A-15I) are completed by the user prior to the remainder of the design process so that the designer has a lot of information about the design project prior to the first collaborative meeting with the user. The design process is more efficient since the initial draft of the design project already will have a significant amount of user input due to the questionnaire and the image library in accordance with the invention. In a preferred embodiment of the invention, the questionnaire is an extended markup language (XML) based questionnaire that asks substantially similar questions to those shown in FIGS. 14A-14M. In the preferred embodiment, the XML-based questionnaire is integrated with the image database (an example of which is shown in FIG. 15A-I) wherein the image database is launched once the user has completed the questionnaire in order to select various design elements of the design project.

FIGS. 15A-I are diagrams illustrating an example of a preferred embodiment of an image database 500 that is part of the on-line design process in accordance with the invention. The image library 500 is presented to the user once the questionnaire is filled out. The image library permits the user to visually review examples of various design aspects of a landscape design, select a particular location for a particular design aspect, such as a bridge, and then provide comments to the designer. When the system is used for other design projects, such as interior design and the like described above, the image library will contain images of the design aspects relevant to that particular design project. This image library is used at the beginning of the design process so that the designer has some guidance from the client/user prior to starting the collaborative on-line design process. FIG. 15A is a starting page of the image library 500. To start using the image library, a user may click on a begin link 502 that transfers the user to a library page 504 as shown in FIG. 15B. On this library page, the user may select a particular aspect of the design project, such as the elevation and plan views, hardscape features, hardscape materials, inbox, lighting, plants and themes and styles. When the user selects a particular design aspect, such as by clicking on a hardscape features link 506, a more detailed design page 508 as shown in FIG. 15C is shown to the user. In accordance with the invention, each design aspect shown in FIG. 15B has its own associated more detailed design page. The more detailed design page 508 allows the user to further specify a particular design aspect of the hardscape features (in the example shown in FIG. 15C) to view. For example, the user may select the bridges design aspect by clicking on a bridges link 510 so that a bridges page 512 as shown in FIG. 15D is shown to the user. In accordance with the invention, each of the particular design aspects shown in FIG. 15C as well as the particular design aspects of the other more detailed design pages that are not shown will have a page such as the bridges page 512.

FIG. 15D illustrates an example of the bridges design aspect page 512 that is displayed to the user. From this page, the user may select a type/style of bridge that the user would like to have incorporated into his/her design process. For example, the user may select a particular bridge style, such as by clicking on a particular bridge image 514. When the user clicks on the image, the user is presented with a design item page 516 shown in FIG. 15E. The page may include an expanded image 518 of the particular bridge, a placement portion 520, a comment portion 522 and an add to favorites link 524. The placement portion 520 (that appears in each particular design item page) is a pull-down menu that permits the user to select the location in the landscape design for the particular design item. For example, the user may select to place the design item in the rear of the property, front of the property and the like. The comment portion 522 (that appears in each particular design item page) permits the user to provide any further comments about the about the particular design item. When the user has selected the placement of the design item and provide any comments, the user may click on the link 524 to add the information into the client's record so that it can then be reviewed by the designer of the landscape project.

FIG. 15F illustrates a more detailed design aspect page 530 for the elevations and plan view item that is selected by a link 528 as shown in FIG. 15B. The elevation views are views of the look and feel of the landscape/property from the front of the property. For example, a pool elevation may provide the user with an example of what the pool would look like when the pool is completed. When the user selects a particular plan/elevation view 532, the user is presented with a design item page 534 that has the expanded image, the placement portion 520, the comments portion 522 and the link 524 as shown in FIG. 15G.

FIG. 15H illustrates a more detailed design aspect page 540 for an inbox item that is selected by a link 539 as shown in FIG. 15B. The page 540 shows one or more different hardscape elements that may include ideas for designing, mountain like gardens and presentation images as shown in FIG. 15H. As with the other pages, the user may select an image 542. Then, a design item page 544 shown in FIG. 151 is displayed to the user. As with the other design item pages, the page may include an expanded image, the placement portion 520, the comments portion 522 and the link 524. Thus, using the image library in accordance with the invention, the user, prior to starting the collaborative design process, can provide the designer with design ideas and preferences by viewing the images from the image library.

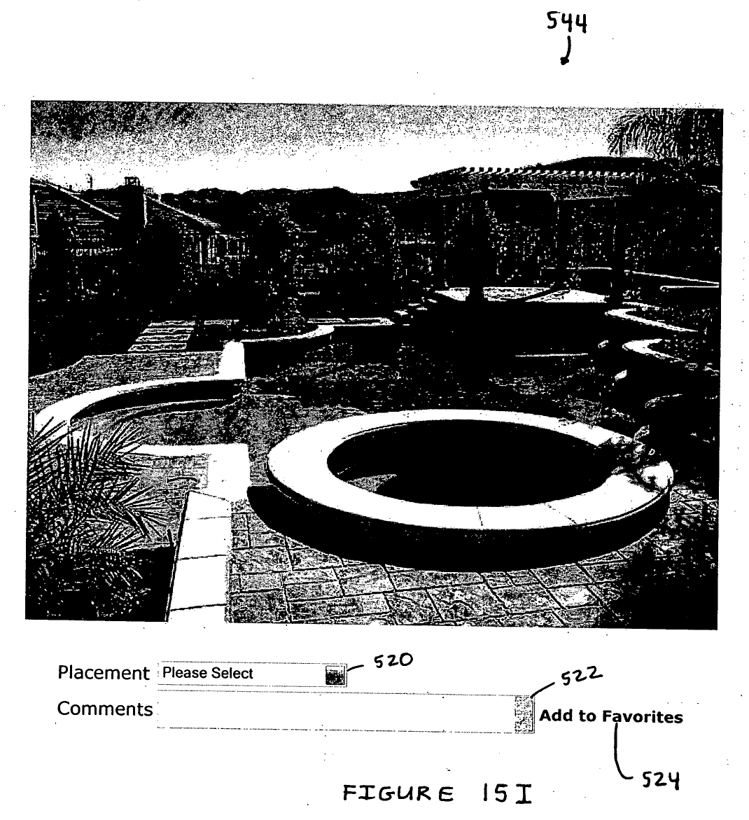

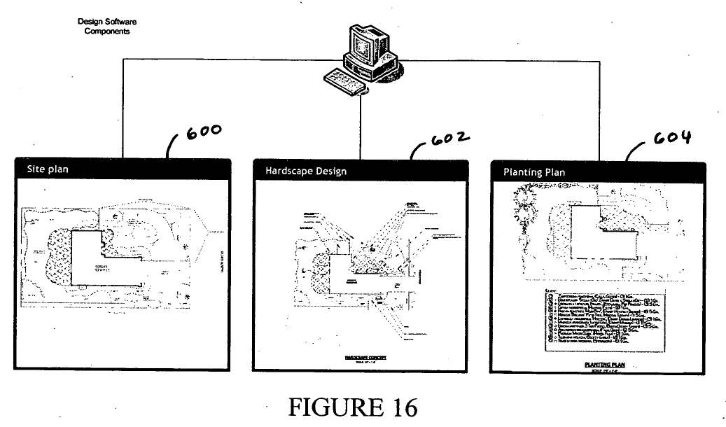

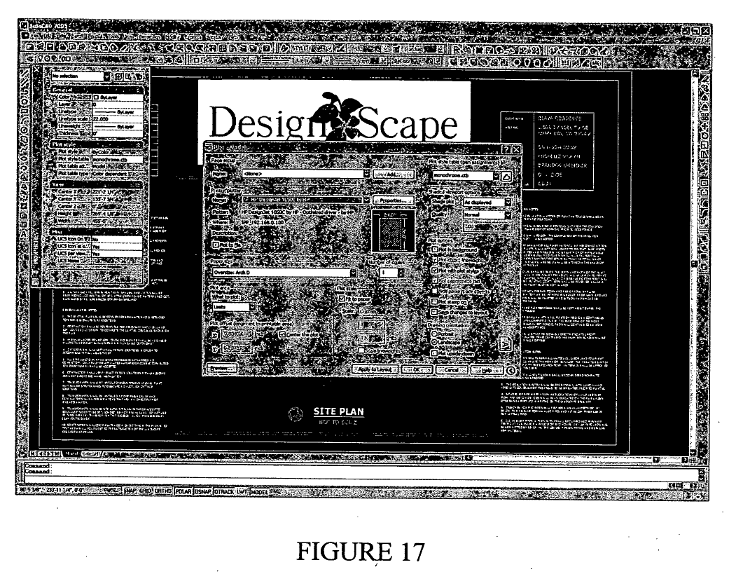

FIG. 16 illustrates an example of the design process in accordance with the invention in which the system is able to design and generate, at least a site plan 600, a hardscape design plan 602 and a planting plan 604. FIG. 17 is a screen shot of an example of a site plan design process in accordance with the invention and FIG. 18 is a screen shot of an example of a hardscape plan design process in accordance with the invention.

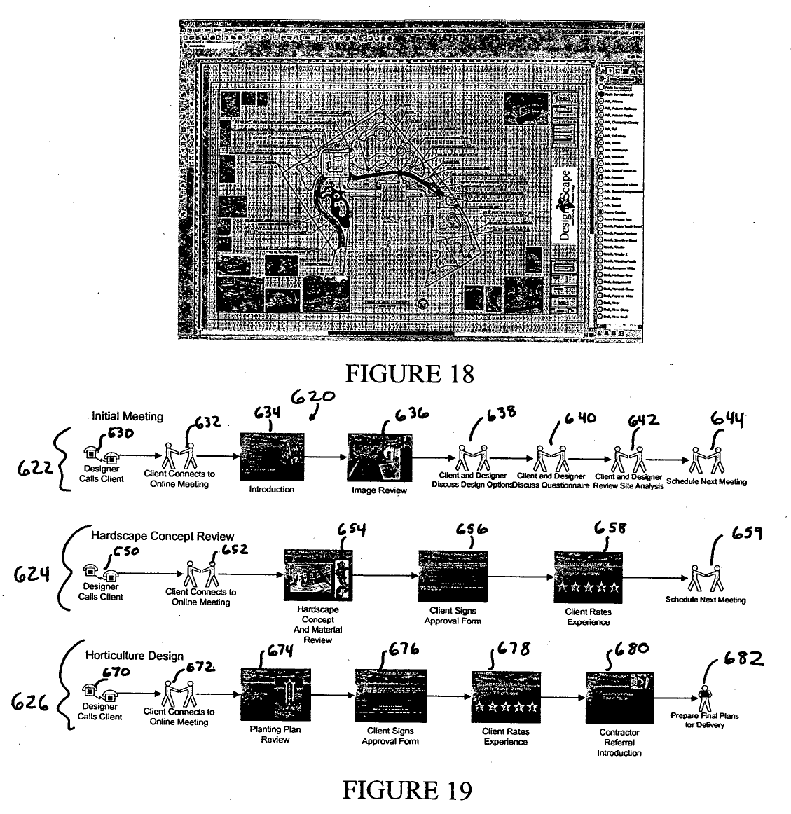

FIG. 19 shows the user design experience 620 in accordance with the invention. The design experience may include an initial meeting process 622, a hardscape concept review process 624 and a horticulture design process 626. During the initial meeting, a designer for the project may call the client in step 630 and have an on-line meeting with the client in step 632. In step 634, an introduction screen is presented to the client/user. In step 636, an image review is collaboratively completed with the client during which the designer and client collaboratively review the various photographs taken of the client's property. In step 638, the client and design discuss the design options. Part of this discussion is based on the images selected by the user/client from the image library in step 640. In step 642, the client and designer review the site analysis and then schedule a next meeting in step 644.

During the hardscape concept review process 624, the designer calls the client in step 650 and starts an on-line meeting in step 652. In step 654, the hardscape concept and materials is reviewed. This hardscape design concept was created by the designer prior to the on-line meeting so that the on-line meeting may be used to review and make changes to the hardscape design plan. In step 656, the client approval of the hardscape design occurs. In step 658, the client has the ability to rate the experience and then a next meeting is scheduled in step 659. During the horticulture design process 626, the designer calls the client in step 670 and the on-line meeting occurs in step 672. In step 674, the planting plan is reviewed. Again, the planting plan is prepared by a horticultural expert so that the on-line meeting is used to review that plan. In step 676, the client approves the planting plan and can rate the experience in step 678. In step 680, the client is introduced to the contractor referral process that is part of the on-line design system in accordance with the invention. In step 682, the final plans generated by the design process are prepared. Using this process, the on-line design process delivers efficient, high quality landscape design plans.

While the foregoing has been with reference to a particular embodiment of the invention, it will be appreciated by those skilled in the art that changes in this embodiment may be made without departing from the principles and spirit of the invention, the scope of which is defined by the appended claims.

1. A system for online design, comprising:
a storage unit containing one or more pieces of information about a design project;
a first computer connected to the storage unit;
one or more client computers that connect to the first computer over a network, the client computers further comprises a client computer and a designer computer;
the first computer further comprises a design tool having a web collaboration module and an image library stored in the storage unit; and
wherein the web collaboration module permits a client and a designer to interactively collaborate on the design project over the network using the client computer and the designer computer so that the collaboration produces a set of plans for the design project that are stored in the storage unit, and wherein the image library has a plurality of images of a plurality of different aspects of the design project so that, prior to using the web collaboration module, the client selects one or more images from the image library to identify one or more desired aspects of the design project.

2. The system of claim 1, wherein the design project is a landscape design.

3. The system of claim 2, wherein the set of plans further comprises one or more of a hardscape design plan, a planting design plan, a lighting design plan, an elevation design plan, an acoustic design plan and an irrigation design plan.

4. The system of claim 3, wherein the plurality of images further comprises one or more of a sit plan, a set of elevation and plan images, a set of lighting images, a set of plant images, a set of hardscape feature images, a set of hardscape material images and a set of themes and style images.

5. The system of claim 4, wherein each image in the image library further comprises an enlarged image portion, a placement portion and a comment portion wherein the placement portion permits the client to select the location of the design aspect shown in the image in the design project.

6. The system of claim 1, wherein the design project is a remodel.

7. The system of claim 1, wherein the design project is a interior design project.

8. The system of claim 1, wherein each image in the image library further comprises an enlarged image portion, a placement portion and a comment portion wherein the placement portion permits the client to select the location of the design aspect shown in the image in the design project.

9. The system of claim 1, wherein the design system further comprises a mechanism that extracts the one or more plans from the database and generates a hard copy of the one or more plans.

10. The system of claim 1, wherein the storage unit further comprises a contactor database containing a plurality of contractors and wherein the design system further comprises a referral module whereby the one or more plans stored in the storage unit are provided to a contractor in the contractor database.

11. The system of claim 1, wherein the first computer further comprises a questionnaire module wherein the client enters a plurality of pieces of information associated with the design project that are stored in the storage unit, the plurality of pieces of information associated with the design project being reviewed by the designer prior to using the web collaboration tool.

12. A method for on-line design of a design project, comprising:
responding to a series of design project questions wherein the responses to the questions are stored in a storage unit;
selecting one or more images from an image library, wherein the selected images are images of different aspects of the design project;
generating a set of design plans based on the selected images and the responses to the questions; and
finalizing the set of design plans based on a collaborative interaction between a designer and a client wherein the designer and client can both modify the set of design plans.

13. The method of claim 12, wherein the design project is a landscape design.

14. The method of claim 13, wherein the set of design plans further comprises one or more of a hardscape design plan, a planting design plan, a lighting design plan, an elevation design plan, an acoustic design plan and an irrigation design plan.

15. The method of claim 14, wherein the plurality of images further comprises one or more of a sit plan, a set of elevation and plan images, a set of lighting images, a set of plant images, a set of hardscape feature images, a set of hardscape material images and a set of themes and style images.

16. The method of claim 15, wherein each image in the image library further comprises an enlarged image portion, a placement portion and a comment portion wherein the placement portion permits the client to select the location of the design aspect shown in the image in the design project.

17. The method of claim 12, wherein the design project is a remodel.

18. The method of claim 12, wherein the design project is a interior design project.

19. The method of claim 12, wherein each image in the image library further comprises an enlarged image portion, a placement portion and a comment portion wherein the placement portion permits the client to select the location of the design aspect shown in the image in the design project.

20. The method of claim 12 further comprising extracting the set of finalized design plans and generating a hard copy of the set of design plans.

21. The method of claim 12 further comprising referring the design project to a contractor that is part of a referral network and providing the set of design plans for the design project to the contractor so that that contractor may bid on the design project.
